(19) United States
(12) Patent Application Publication
(10) Pub. No.: US 2023/0263185 A1
(43) Pub. Date: Aug. 24, 2023

(54) Stirring Apparatus for Direct Expansion Evaporator of Ice Cream or Yogurt Machine

(71) Applicant: Lingyu DONG, Temple City, CA (US)

(72) Inventor: Lingyu DONG, Temple City, CA (US)

(21) Appl. No.: 17/676,110

(22) Filed: Feb. 18, 2022

(51) Int. Cl. A23G 9/22; B01F 27/1145; B01F 27/091

(52) U.S. Cl. CPC A23G 9/224; B01F 27/091; B01F 27/11451; B01F 2101/13

(57) ABSTRACT

The stirring apparatus includes a stirring beater configured to be coaxially disposed in a mixing chamber of a freezing cylinder in a rotatable manner for pushing a mixture flowed in the mixing chamber in an inner spiral manner, and one or more scraper blades. The stirring beater includes one or more helical stirring paddles supported by a central frame and spirally extended along a length of the mixing chamber. The one or more scraper blades are mounted along the one or more helical stirring paddles respectively to define a helical diameter matching with an inner diameter of the mixing chamber of the freezing cylinder such that each of the one or more scraper blades is capable of scrapping against an inner surface of the freezing cylinder while a rotation of the stirring beater within the mixing chamber of the freezing cylinder

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention generally relates to a heat exchange apparatus, and more particular to a stirring apparatus for direct expansion evaporator for a refrigeration system.

### Description of Related Arts

Frozen product, such as ice cream and yogurt, has been popular for decades around the world, which is made from mixture of dairy products, fruits or other ingredients and flavors with ice. A direct expansion evaporator for heat exchanging, such as a heat exchanger, is utilized in the ice cream or yogurt machine. For example, U.S. Pat. No. US 8,534,086 B2 which discloses a direct expansion evaporator for making a frozen product from raw material, including a feeding channel, a heat exchange channel thermally communicating with the feeding channel, and a refrigerant flowing within the heat exchange channel for exchanging heat between the raw material within the feeding channel and the refrigerant within the heat exchange channel in an expanded evaporation manner. U.S. Pat. No. US11,019,832 discloses an expansion evaporator including a heat exchanger and a replaceable freezer cylinder detachably received with in a receiving channel of the heat exchanger, as shown in FIG. 1A, wherein a mixing module for enhancing the transformation from the raw material to the frozen product is arranged within the feeding channel of the replacement freezer cylinder and comprises a beater device rotatable in the feeding channel of the replacement freezer cylinder and a motor device for driving the beater device to rotate to mix and stir the raw material within the feeding channel.

In other words, the conventional mixing module is driven by electrical motor to stir the mixture to be evenly mixed without large sized ice. However, the material of beverage is hard to be well-distributed with the chum paddles of the conventional mixing machine. Since the size of different ingredients are vary from qualities between the materials, all kinds of the ingredients are difficult to be smashed into same sized pieces as required.

Accordingly, the conventional mixing module only provides a rotating force along the driving axis, so the mixture is pushed to move along the axis, just like going straight along the axis in different radius. So, the mixture has little chance to be crashed into pieces. On the other hand, the conventional mixing module is easily to get frosted on the inner wall of the canister or on outer surface of elements inside the machine when dealing with freezing beverage. Especially, the conventional mixing module is in complex structure and has multidirectional edges to be stocked with large-sized ingredients which are fertile breeding grounds for bacteria. In addition, the conventional mixing module provides a baffle extended along the driving axis so that the baffle has to be suffered against the rotating force to wear out as time passed by, so that the conventional mixing module is facing corrosion which will cause hygienic problem to the mixture of food.

Referring to FIG. 1B, U.S. Pat. No. US10,806,163B2 discloses a beater device with scraper blade arrangement for carbonated beverage apparatus, that is capable of stirring a plurality of ingredients in an inner spiral manner to mix into a frozen carbonated beverage mixture sufficiently comprises a stirring pusher which is disposed in a freezing cylinder to mix evenly for making the carbonated beverage mixture and capable of constantly removing the frozen ingredients from an inner wall of the freezing cylinder radially back into the center portion of the freezing cylinder, a baffle driven by a motor and configured to be rotated inside the freezing cylinder and the baffle is blocked the flowing path of the ingredients, so all kinds of the ingredients can be broken up into pieces, and one or more scraper blades detachably mounted on a supporting frame to remove the ingredients from the inner wall of the freezing cylinder to avoid frosting and wasting.

However, the supporting frame of the ‘163 patent must be provided and extended between two ends of the beater device for the helical paddle being affixed thereon spirally and the scraper blades being mounted thereon. Since the scraper blades are elongated blades linearly mounted on the supporting frame, the rotation of the beater device can merely drive the scraper blades to scrape against the inner wall of the freezing cylinder in an axial manner to remove the ingredients from the inner wall of the freezing cylinder, wherein the precision of the scraper blades with respect to the diameter of the freezing cylinder is an essentially critical. Especially when the scraper blades are detachably mounted on the supporting frame through the scraper gripper. When there is too much ingredient frozen around the inner wall of the freezing cylinder, the excessive friction may pull the scraper blade to detach from the gripping slot and the projection of the scraper gripper, resulting in the need to stop the machine and remount the scraper blade in position.

### SUMMARY OF THE PRESENT INVENTION

The invention is advantageous in that it provides a stirring apparatus for direct expansion evaporator of ice cream or yogurt machine, which comprises one or more scrapper blades configured to be spirally and detachably mounted along one or more helical stirring paddles of a stirring beater coaxially, such that the scrapper blades are able to flexibly, effectively and efficiently scrape against the inner wall of the freezing cylinder helically while the rotation of the stirring beater.

Another advantage of the invention is to provide a stirring apparatus for direct expansion evaporator of ice cream or yogurt machine, which one or more scraper blade are spirally mounted to press against the circular inner wall and define a helical diameter precisely fitted with a diameter of a mixing chamber of the freezing cylinder coaxially with respect to the stirring beater so as to perform effective and efficient scraping and stirring movements simultaneously.

Another advantage of the invention is to provide a stirring apparatus for direct expansion evaporator of ice cream or yogurt machine, wherein the one or more scraper blades are detachably mounted along the one or more helical stirring paddles in such a manner that it is easy to be replaced promptly.

Another advantage of the invention is to provide a stirring apparatus for direct expansion evaporator of ice cream or yogurt machine, which helical stirring paddles are configured to be capable of mounting one or more elongated scraper blades thereon in a fix or detachable manner.

Another advantage of the invention is to provide a stirring apparatus for direct expansion evaporator of ice cream or yogurt machine, wherein the front end of the beater device provides a supporter, having an outlet opening, configured to be mounted in the mixing chamber of the freezing cylinder in a rotatable manner with respect to the rotation of the beater device in the mixing chamber of the freezing cylinder coaxially, providing a more effective scrapping and mixing effect.

Additional advantages and features of the invention will become apparent from the description which follows and may be realized by means of the instrumentalities and combinations particular point out in the appended claims.

According to the present invention, the foregoing and other objects and advantages are attained by a stirring apparatus for a direct expansion evaporator comprising a freezing cylinder having a circular mixing chamber therein, comprising:
a stirring beater configured to be coaxially disposed in the mixing chamber of the freezing cylinder in a rotatable manner for pushing a mixture flowed in the mixing chamber in an inner spiral manner while stirring, smashing and mixing the mixture which is served as frozen product out of the freezing cylinder, wherein the stirring beater comprises a front supporter configured for mounting at a front end member of the freezing cylinder, one or more helical stirring paddles and a central frame configured to support the one or more helical stirring paddles spirally extended from the front supporter to a rear end portion thereof; and
one or more scraper blades mounted along the one or more helical stirring paddles respectively to define a helical diameter matching with an inner diameter of the mixing chamber of the freezing cylinder such that each of the one or more scraper blades is capable of scrapping against an inner surface of the freezing cylinder while a rotation of the stirring beater within the mixing chamber of the freezing cylinder.

In one embodiment, each of the one or more scraper blades is arranged to remove the mixture from an inner wall of the freezing cylinder back into the stirring pusher.

In one embodiment, each of the one or more scraper blades comprises a main body and two scraping arms outwardly and slantly extended from the main body integrally to form a general Y shape such that a scraper cavity is defined between the two scraping arms and the inner surface of the freezing cylinder while the scraper blade is press against the inner surface of the freezing cylinder.

In one embodiment, the one or more helical stirring paddles of the stirring beater is extended in spiral manner along an axial of the stirring beater for smashing the ingredients of the mixture while pushing the mixture move from an inlet to an outlet of the freezing cylinder.

In one embodiment, the central frame comprises an axial bar having one end configured to be rotatably mounted to a rear end of freezing cylinder and configured to be driven by a motor to be rotated in the mixing chamber of the freezing chamber, and a beater ring disposed between the front supporter and the rotor bar, wherein the one or more stirring paddles which are supported by the rotor bar are connect with the beater ring so as to support the beater ring coaxially with the rotor bar.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1A is a perspective view of a conventional beater device.

FIG. 1B is an exploded perspective view of the conventional beater device as shown in FIG. 1A.

FIG. 2 is an exploded perspective view of a stirring apparatus according to a preferred embodiment of the present invention.

FIG. 3 is a sectional view of the stirring apparatus according to the above preferred embodiment of the present invention.

FIG. 4 is an enlarged sectional view illustrating the scraper blade pressing against the inner surface of freezing cylinder according to the above preferred embodiment of the present invention.

FIG. 5 is a perspective view of the stirring apparatus according to the above preferred embodiment of the present invention.

FIG. 6 is an exploded schematic view illustrating a direct expansive evaporator of ice cream or yogurt machine comprising the stirring apparatus according to the above preferred embodiment of the present invention.

FIG. 7 is a perspective view of an alternative mode of the stirring apparatus according to the above preferred embodiment of the present invention.

FIG. 8 is an exploded schematic view illustrating the direct expansive evaporator of ice cream or yogurt machine comprising the stirring apparatus according to the above alternative mode of the preferred embodiment of the present invention.

FIG. 9 is a perspective view of another alternative mode of the stirring apparatus according to the above preferred embodiment of the present invention.

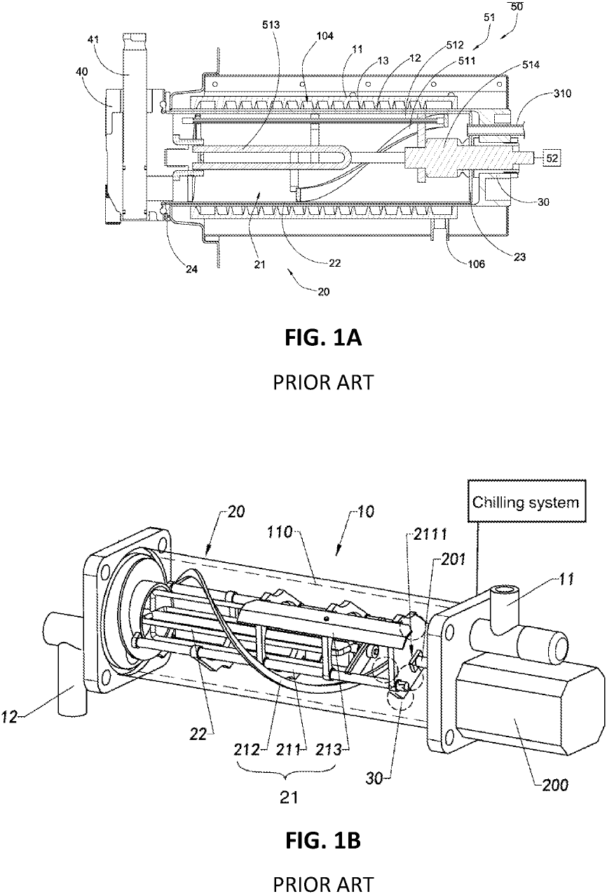

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

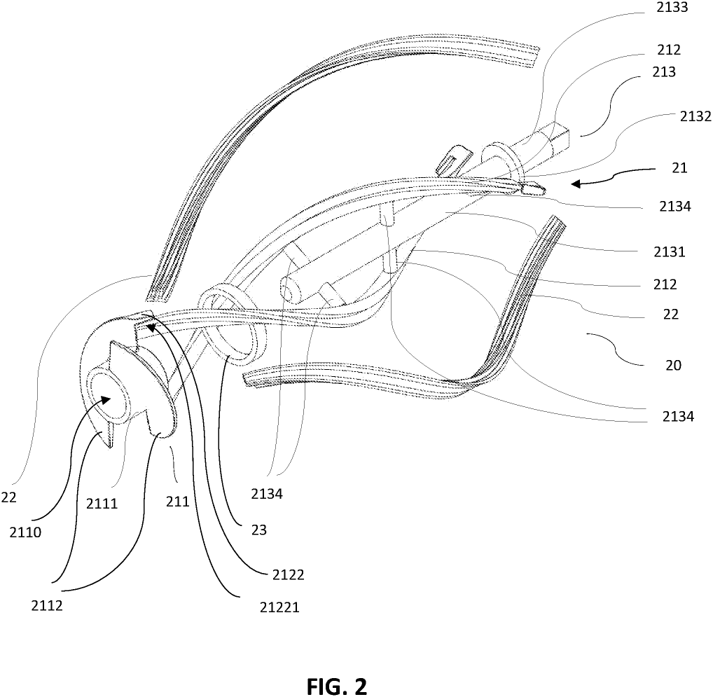

The present invention provides a stirring apparatus 20, as shown in FIG. 2 to FIG. 5, adapted to be installed in a mixing chamber 100 of a freezing cylinder 10 to form a direct expansion evaporator of ice cream or yogurt machine, which is adapted to push and mix a mixture from an inlet 11 to an outlet 12 thereof in an inner spiral manner. Furthermore, the stirring apparatus 20 is driven by a motor 200 to be rotated in the freezing cylinder 10 along a driving axis 201 of the stirring apparatus 20 which is the same as the centerline axis of the freezing cylinder 10. When the stirring apparatus 20 is rotating, the mixture is being pushed to move from the inlet 11 to the outlet 12. And as the outlet 12 is opened, the mixture is served as frozen product, such as ice cream or yogurt, flowing out of the mixing chamber 100 of the freezing cylinder 10.

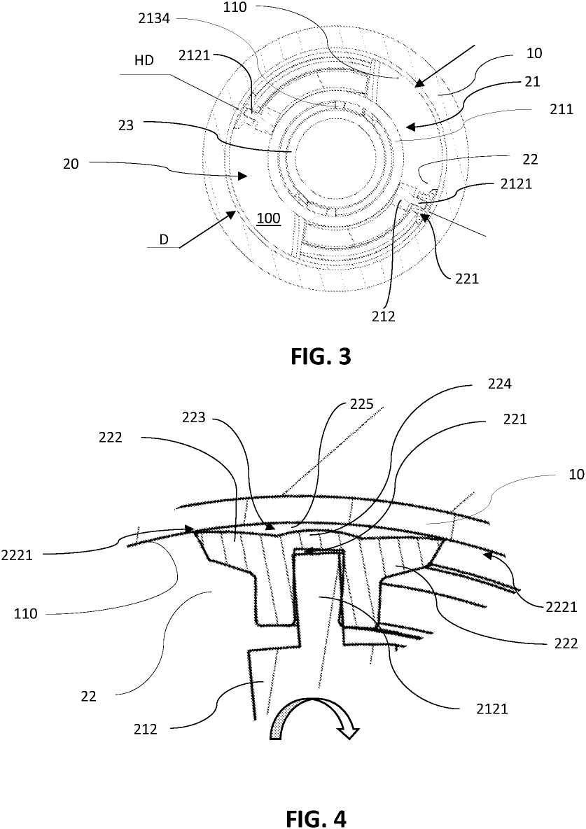

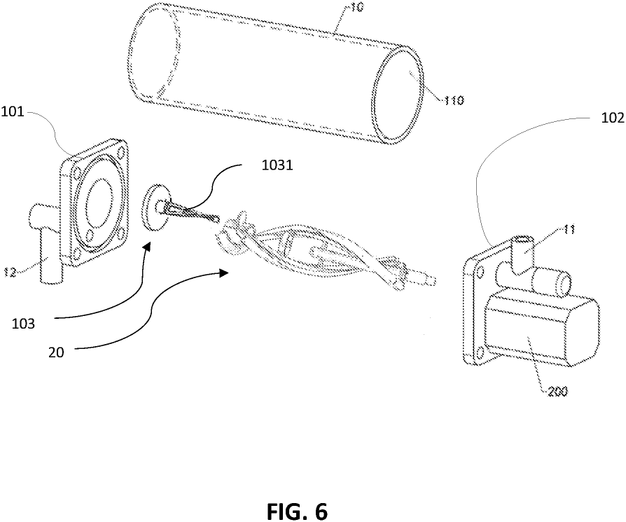

Referring to FIGS. 3 and 6, the freezing cylinder 10 is firstly fed with ingredients of the mixture which is flowed inside the freezing cylinder 10 with being mixed into the mixture 30. The freezing cylinder 10 has an inner surface 110 contacted or touched by the stirring apparatus 20. As the mixture is chilled and tends to attach on the inner surface 110, which is willing to get frost on the inner surface 110, the mixture is capable of being moved from the inner surface 110 back into the freezing cylinder 10. Accordingly, the stirring apparatus 20 is configured and arranged to push the mixture to move forwards and inwards in the freezing cylinder 10.

As shown in FIGS. 2 to 5, the stirring apparatus 20 comprises a stirring beater 21 and one or more scraper blades 22. The stirring beater 21 is configured to be coaxially disposed in the mixing chamber 100 of the freezing cylinder 10 in a rotatable manner for pushing the mixture flowed in the mixing chamber 100 in an inner spiral manner while stirring, smashing and mixing the mixture which is served as frozen product out of the freezing cylinder 10. The stirring beater 21 comprises a front supporter 211 configured for rotatably mounting at a front member 101 of the freezing cylinder 10, one or more helical stirring paddles 212 and a central frame 213 configured to support the one or more helical stirring paddles 212 spirally extended from the front supporter 211 to a rear end portion of the axial frame 213, such that the mixture injected from the inlet 11 is pushed to move in an inner spiral manner by the stirring beater 21. The mixture moves along the freezing cylinder 10 while being chilled from the inlet 11 to the outlet 12 and along the direction of from the inner surface 110 to the stirring paddles 212 of the stirring beater 21. Therefore, the mixture is moving along an inner spiral line pushed by the stirring beater 21, and the one or more stirring paddles 212 stir and smack the mixture in an outer portion of the mixing chamber 110 so as to evenly mix and smash to make the frozen product. Accordingly, the stirring beater 21 is arranged to radially stir and move the mixture 30 from a peripheral portion of the freezing cylinder 10 to a center portion thereof, while the one or more stirring paddles 212 are arranged to stir the mixture the freezing cylinder 10.

The stirring apparatus 20 further comprises one or more scraper blades 22 mounted along the one or more helical stirring paddles 212 respectively to define a helical diameter HD matching with, preferably slightly larger than, an inner diameter D of the mixing chamber 100 of the freezing cylinder 10, as shown in FIG. 3, such that each of the one or more scraper is capable of scrapping against the inner surface 110 of the freezing cylinder 10 while a rotation of the stirring beater 20 within the mixing chamber 100 of the freezing cylinder 10.

According to the preferred embodiment of the present invention, the central frame 213 comprises an elongated axial bar 2131, a circular end rotor 2132 radially and integrally protruded at a rear end of the axial bar 2131 for rotatably mounting, e.g. through a bearing, to a rear member 102 of the freezing cylinder 10, and a driven shaft 2133 rearwardly extended from the end rotor 2132 for being driven by the motor 200 mounted on the rear member 102 of the freezing cylinder 10 to rotate the central frame 213 in the mixing chamber 100 coaxially, as shown in FIGS. 2, 3 and 5.

The central frame 213 further comprises two or more beater elements 2134 radially extended from the axial bar 2131, wherein the baffle elements 2134 are preferred to be extended between the axial bar 2131 and the one or more stirring paddles 212 so as to be positioned around the axial bar 2131 and surrounded by the stirring paddles 212 radially, such that when the mixture is moving along the inner spiral line pushed by the stirring beater 21, the beater elements 22 substantially block the flowing path of the mixture to further evenly mix and smash the mixture in an inner portion of the mixing chamber 100 to make the frozen product. In other words, while the stirring beater 21 is arranged to radially stir and move the mixture from the peripheral portion of the freezing cylinder 10, the beater elements 2134 are also arranged to stir the mixture within the inner portion (space between the stirring paddles 212) of the freezing cylinder 10.

According to the preferred embodiment of the present invention, a pair of the scraper blades 22, a pair of the helical stirring paddles 212 and three pairs of the beater elements 2134 are provided. The axial bar 2131 has a front end extended to a middle position of the freezing cylinder 10. A first pair of the beater elements 2134 is radially and respectively extended at two opposing sides of a front portion of the axial bar 2131, having the same length and being aligned in opposite direction radially. A second pair of the beater elements 2134 is radially and respectively extended at two opposing sides of a rear portion of the axial bar 2131, having the same length and being aligned in opposite direction radially. At least a third pair of the beater elements 2134 is radially and respectively extended at two opposing sides of a middle portion of the axial bar 2131, having the same length and being aligned in opposite directions radially. The three pairs of beater elements 2134 are positioned in stagger manner that not only provides more even and better stirring, smashing and mixing ability for the mixture in the mixing chamber 100, but also provides rigid and balancing support to the pair of the helical stirring paddles 212.

Each of the pair of stirring paddles 212 is preferred to be extended in a 180~360 degrees spiral manner, preferably 270 degrees, along the length of the mixing chamber 100 of the freezing cylinder 10, as shown in FIG. 2, wherein the two helical stirring paddles 212 are preferred to be spirally extended in opposite directions such that, in every cross section of the stirring apparatus 20 within the freezing cylinder 10, as shown in FIG. 3, the two stirring paddles 212 are opposing with each other. In other word, the two stirring paddles 212 are extended along the entire length of the mixing chamber 100 and the inner surface 110 of the freezing cylinder 10 are continuously scraped by the pair of scraper blades 22 symmetrically.

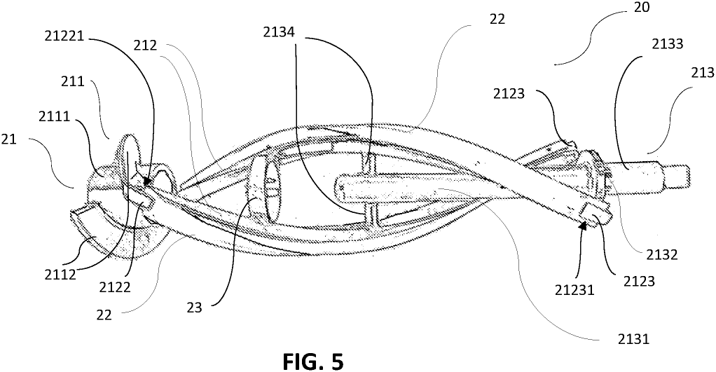

It is noted that the axial bar 2131 and each of the beater elements 2134 may have any sectional shape. According to the preferred embodiment, the axial bar 2131 and the beater elements 2134 are embodied to each having a circular sectional shape, as shown in FIGS. 2 and 5, that is good for mixture stirring and smashing effect.

Since the pair of stirring paddles 212 are helically extended in a symmetrical manner, the first pair of the beater elements 2134 are outwardly and radially extended from the front end portion of the axial bar 2131 to connect with the stirring paddles 212 respectively, the third pair of the beater elements 2134 are outwardly and radially extended from a middle portion of the axial bar 2131 to connect with the stirring paddles 212 respectively, and the third pair of the beater elements 2134 are outwardly and radially extended from the rear end portion of the axial bar 2131 to connect with the stirring paddles 212, so as to rigidly support the pair of stirring paddles 212 to extended along the mixing chamber 100 of the freezing cylinder 10 in the spiral manner as shown in FIG. 2.

Generally, the ingredients of the mixture fed through the inlet 11 into the mixing chamber 100 of the freezing cylinder 10 are well smashed and mixed by the beater elements 2134 in the rear half section of mixing chamber 100 of the freezing cylinder 10, i.e. the section that the axial bar 2131 is positioned, and the stirring paddles 212 and the mixture is frozen to produce the ice cream or yogurt product, which is ready to discharge through the outlet 12 of the freezing cylinder 10, in the front half section of the mixing chamber 100 of the freezing cylinder 10, i.e. the section between the front supporter 211 and the front end portion of the axial bar 2131. In order to further support the pair of stirring paddles 212 and provide additional stirring effect to the mixture in the front half section of the mixing chamber 100 of the freezing cylinder 10, the stirring beater 21 further comprises a beater ring 23 positioned between the front supporter 211 and the axial bar 2131 and coaxially connected with the pair of the stirring paddles 212, such that the front portion of each of the stirring paddles 212 is well supported by the beater ring 23 and the beater ring 23 also provides a stirring and continuously mixing effect to the frozen mixture in the front half section of mixing chamber 100 before discharging through the outlet 12 of the freezing cylinder 10.

According to the preferred embodiment, the front supporter 211 comprises a tubular supporter body 2111 having an axial opening 2110 for rotatably mounting on the front member 101 of the freezing cylinder 10 so as to rotatably and coaxially support the stirring beater 21 to the front member 101 of the freezing cylinder 10. In other words, the rotatably connection of the front member 101 and the rear member 102 of the freezing cylinder 10 with the front supporter 211 and the end rotor 2132 respectively, the stirring beater 21 is coaxially support in the mixing chamber 100 of the freezing cylinder 10 in a rotatable manner. The front supporter 211 further comprises one or more spiral blades 2112, preferably a pair of symmetrical spiral blades 2112 as shown in FIG. 2, which further provide stirring and mixing effect to the frozen mixture before discharged through the outlet 12.

Two front ends of the pair of the stirring paddles 212 are connected to the pair of the spiral blades 2112 and extended therefrom respectively and two rear ends of the pair of the stirring paddles 212 are extended to a position adjacent to the end rotor 2132, such that the two stirring paddles 212 are fully extended along an axial length of the mixing chamber 100 of the freezing cylinder 10.

Referring to FIGS. 2 to 4, each of the stirring paddles 212 has an elongated retaining rail 2121 protruded along an outer side of the stirring paddle 212. Correspondingly, each of the scraper blades 22 has a retaining slot 221 indented along an inner side thereof, which is sized and shaped to fit the retaining rail 2121 of the corresponding stirring paddle 212 therein, forming a rail and slot configuration, so as to detachably retain the pair of the scraper blades 22 on the outer sides of the pair of the stirring paddles 212 respectively. The scraper blades 212 are made of elastic material, such as plastic, rubber or silicon material, for providing best pressing and scrapping effect against the inner surface 110 of the freezing cylinder 10 during the rotation of the stirring apparatus 20. Therefore, when the retaining slot 221 is slightly smaller than the sectional size of the retaining rail 2121, the elastic effect of the scraper blade 22 provides a tight engaging and holding effect to mount on the corresponding stirring paddle 212.

It is appreciated that the retaining rail 2121 may also be embodied as a recessed slot indented along the outer side of the stirring paddle 212, and that a cross section of the retaining rail 2121 can be generally in rectangular or wedge shape. When the retaining rail 2121 is embodied as a recessed slot, the scraper blade 22 forms a retaining ridge protruded along the inner side thereof to insert into the recessed slot type retaining rail 2121.

Referring to FIG. 4, in order to provide effective and efficient scrapping ability, each of the scraper blades 22 comprises a pair of scraping arms 222 outwardly and slantly extended from two longitudinal sides of the scraper blades 22 respectively in a symmetrical manner to form a general “Y” sectional shape. Each of the scraping arms 222 gradually reduces its thickness to form a sharp scraping edge 2221 configured for pressing against the inner surface 110 of the freezing cylinder 10. Each of the scraper blades 22 has a concave recess 223 formed and extended longitudinally along an outer side thereof, wherein a central ridge 224 is slightly protruded along the outer side of the scraper blade 22. When the stirring apparatus 20 is rotatably disposed in the mixing chamber 100 of the freezing cylinder 10, the pair of scraper blades 22 are supported to touch the inner surface 100 of the freezing cylinder 10 and only the two scraping edges 2221 of the two scraping arms 222 of each of the scraper blades 22 are pressing against the inner surface 110 with a predetermined pressure facilitating scraping against the frost mixture attached on the inner surface 110 during rotation of the scraper blade 22 that a scraper cavity 225 is defined between the two scraping edges 2221 of the two scraping arms 222 and the inner surface 100 of the freezing cylinder 10. The presence of the central ridge 224 substantially reinforces the two scraper arms 222 and ensures a flexibility of the two scraping edges 2221 to press against the inner surface 110 of the freezing cylinder 10.

Accordingly, while the stirring apparatus 20 is rotating clockwise as illustrated in FIG. 4, the scraper blade 22 is moved to press against the inner surface 110 and the right scraping edge 2221 scrapes against the inner surface 110 to remove the mixture attached on the inner surface 110. Not only the mixture attached on the inner surface 100, the mixture around the inner surface 100 is capable of being radially moved to inside the mixing chamber 100 and to the stirring beater 21 by the right scraper arm 222. In addition, the left scraping edge 2221 will further scrape against the inner surface 110 that has just been scraped by the right scraping edge 2221 to remove smaller frozen mixture that the right scraping edge 2221 didn’t remove. The wedging blade shape of each of the scraping arms 222 substantially facilitates to shovel the mixture attached on and around the inner surface 110. The presence of the scraper cavity 225 also facilitates the rotation movement and the shoveling action of the scraper blade 22 that not only enhances the scraping ability but also reduces the friction between the scraper blade 22 with respect to the inner surface 110 of the freezing cylinder 10.

Since inner diameter of the mix chamber 100 becomes smaller when a layer of frost mixture is firmly attached to the inner surface 110 of the freezing cylinder 10 that the scraper blade 22 may not remove the entire mixture attached to the inner surface 110 once a time, the V configuration of the pair of scaping arms 222 and the formation of the scraper cavity 225 provides a cushion effect that enables the scraper blade 22 to reduce its overall thickness by pressing the scraping edges 2221 inwards to continuously move and pass through while the scraper blade 22 is rotated to shave a portion of the frost mixture in a rotation circle. The scraper blades 22 are continued to be rotated to shave the mixture around and around, the mixture will be removed portion by portion or be shaven around by around from the inner surface 110. It is appreciated that a radius of scraping circle of the scraper blades 22 is fine-tuning while rotating against the inner surface 110 to scrap the frost mixture.

Each of the stirring paddles 212 further comprises a front retainer 2122 and a rear retainer 2123 integrally provided at a front end and a rear end of the corresponding stirring paddle 212 respectively. Each of the front retainer 2122 and the rear retainer 2123 has a L-shape defining a retainer slot 21221, 21231, such that the front end and the rear end of the scraper blade 22 are fittingly retained in the retainer slots 21221, 21231 of the front retainer 2122 and the rear retainer 2123 respectively, so as to further engage and retain the pair of scraper blades 22 to be mounted on the pair of stirring paddles 212 respectively during the rotation of the stirring apparatus 20. It is worth mentioning that the scraper blades 22 are retained on the stirring paddles 212 by means of the rail and slot configuration, especially during the rotation of the stirring beater 21 in the mixing chamber 110 due to the centrifugal force generated and force pressing against the inner surface 110 by the scraper blades 22. The thicker the layer of frost mixture attached on the inner surface 110, the firmer the scraper blades 22 retained to the stirring beater 21 and the pressed against the inner surface 110, while the scraper cavity 225 still provides adjustable movement and cushion effect for the scraper blades 22. During maintenance, the stirring apparatus 20 is removed from the mixing chamber 100 and the scraper blade 22 is easy to detach from the stirring paddle 212 by simply removing the two ends of the scraper blade 22 from the front and rear retainers 2122, 2123 and then separating the scraper blade 22 from the stirring paddle 21. Another replacement new scraper blade 22 can be mounted on the stirring paddle 212 again simply by inserting the retaining rail 2121 into the retaining slot 221 and retaining the two ends of the scraper blade 22 by the front and rear retainers 2122, 2123.

It is appreciated that a rotor 103, which comprises a spiral rotor element 1031 extended rearwardly, is mounted to a center of the front member 101 such that the spiral rotor element 1031 is extended rearwardly and coaxially through the axial opening 2110 of the tubular front supporter 211 and the beater ring 23 so as to further stir and mix the frost mixture in the inner portion of the front half section of the mixing chamber 100 before discharging via the outlet 12. It should also be noted that the scraper blade 22 can be permanently mounted on the stirring paddle 212 by screwing or gluing.

The stirring beater 21 stirs and moves the mixture from the inlet 11 to the outlet 12 by the helical stirring paddles 212 and from the inner surface 110 to a center of the freezing cylinder 10 by the scraper blades 22. Especially, the stirring beater 21 is forced on mixing and pushing the mixture in the freezing cylinder 10. The beater elements 2134 inside the stirring beater 21 are blocking the flowing path of the mixture that significantly smash the ingredients of mixture into pieces and stir the ingredients of mixture back again to evenly mix the mixture with the stirring paddles 212. Thus, the mixture is moving along the inner spiral line pushed by the stirring beater 21 and bumped into the beater elements 2134 and the beater ring 23. Even the front supporter 211 also provides the stirring and mixing effect for the mixture near the outlet 12 so as to ensure well mixed mixture to discharge through the outlet 12.

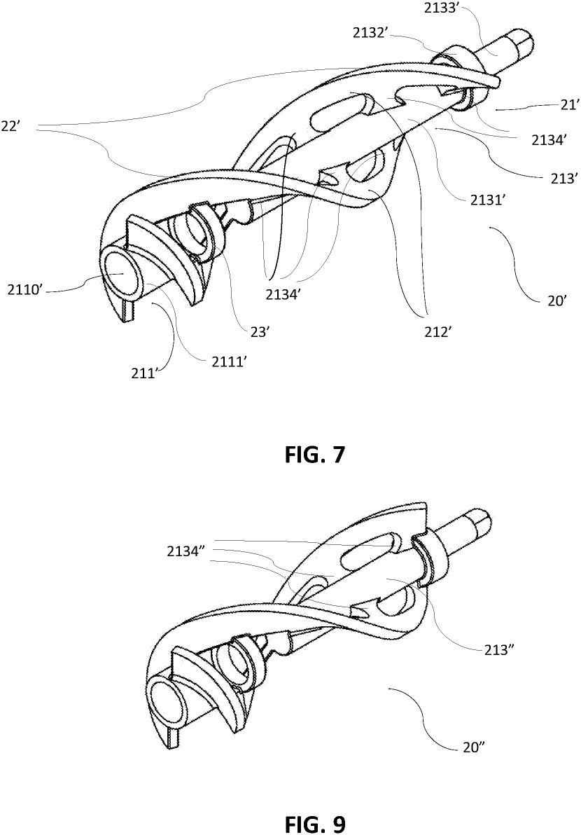

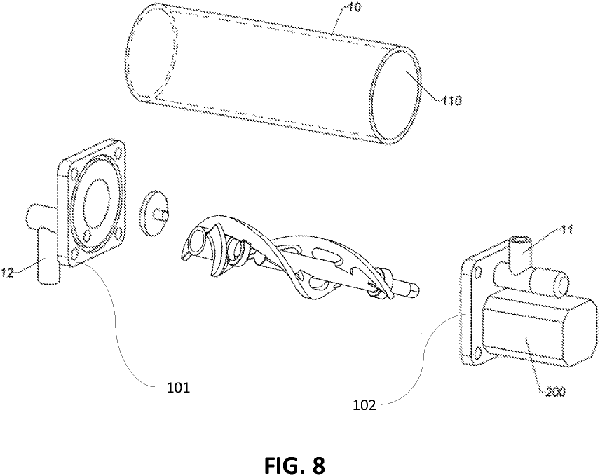

Referring to FIGS. 7 and 8, an alternative mode of the stirring apparatus 20′ is illustrated. The stirring apparatus 20′ is embodied as an integral body made of plastic material such as nylon or POM by molding and comprises a stirring beater 21′ which is configured to be coaxially disposed in the mixing chamber 100 of the freezing cylinder 10 in a rotatable manner for pushing the mixture flowed in the mixing chamber 100 in an inner spiral manner while stirring, smashing and mixing the mixture which is served as frozen product out of the freezing cylinder 10. The stirring beater 21′ comprises a front supporter 211′ configured for rotatably mounting at a front member 101 of the freezing cylinder 10, one or more helical stirring paddles 212′ and a central frame 213′ integrally supports the one or more helical stirring paddles 212′ spirally extended from the front supporter 211′ to a rear end portion of the axial frame 213, such that the mixture injected from the inlet 11 is pushed to move in an inner spiral manner by the stirring beater 21′. The mixture moves along the freezing cylinder 10 while being chilled from the inlet 11 to the outlet 12 and along the direction of from the inner surface 110 to the stirring paddles 212′ of the stirring beater 21′. Therefore, the mixture is moving along an inner spiral line pushed by the stirring beater 21′, and the one or more stirring paddles 212′ stir and smack the mixture in an outer portion of the mixing chamber 110 so as to evenly mix and smash to make the frozen product. Accordingly, the stirring beater 21′ is arranged to radially stir and move the mixture 30 from a peripheral portion of the freezing cylinder 10 to a center portion thereof, while the one or more stirring paddles 212′ are arranged to stir the mixture the freezing cylinder 10.

The stirring apparatus 20′ further comprises one or more scraper blades 22′ integrally formed with the one or more stirring paddles 212′ respectively to define a helical diameter matching with an inner diameter of the mixing chamber 100 of the freezing cylinder 10, such that each of the one or more scraper blades 22′ is capable of scrapping against the frost mixture attached on the inner surface 110 of the freezing cylinder 10 while a rotation of the stirring beater 20′ within the mixing chamber 100 of the freezing cylinder 10. In this alternative mode, the one or more scraper blades 22′ is embodied to be integrally formed along outer edges of the one or more stirring paddles 212′ respectively. When the one or more stirring paddles 212′ and the one or more scraper blades 22′ are molded with the same material, the outer edges of the stirring paddles 212′ form the scraper blades 22′ respectively for scrapping against the inner surface 110 of the freezing cylinder 10.

The central frame 213′ comprises an elongated axial bar 2131′, a circular end rotor 2132′ radially and integrally protruded at a rear end of the axial bar 2131′ for rotatably mounting, e.g. through a bearing, to a rear member 102 of the freezing cylinder 10, and a driven shaft 2133′ rearwardly extended from the end rotor 2132′ for being driven by the motor 200 mounted on the rear member 102 of the freezing cylinder 10 to rotate the central frame 213′ in the mixing chamber 100 coaxially. According to the alternative mode, the driven shaft 2133′ is made of metal and the stirring beater 21′ and scraper blades 22′ are integrally molded on the driven shaft 2133′ and driven by the motor 200 to rotate in the mixing chamber 100 of the freezing cylinder 10.

The central frame 213′ further comprises two or more beater elements 2134′ integrally and radially extended from the axial bar 2131′, wherein the baffle elements 2134′ are preferred to be extended between the axial bar 2131′ and the one or more stirring paddles 212′ so as to be positioned around the axial bar 2131′ and surrounded by the stirring paddles 212′ radially, such that when the mixture is moving along the inner spiral line pushed by the stirring beater 21′, the beater elements 22′ substantially block the flowing path of the mixture to further evenly mix and smash the mixture in an inner portion of the mixing chamber 100 to make the frozen product. In other words, while the stirring beater 21′ is arranged to radially stir and move the mixture from the peripheral portion of the freezing cylinder 10, the beater elements 2134′ are also arranged to stir the mixture within the inner portion (space between the stirring paddles 212′) of the freezing cylinder 10.

According to the alternative mode of the above preferred embodiment of the present invention, a pair of the scraper blades 22′ integrally formed with a pair of the helical stirring paddles 212′ and four pairs of the beater elements 2134′ being integrally connected and supported between the axial bar 2131′ and the pair of the stirring paddles 212′ are provided. The axial bar 2131′ has a front end extended to a middle position of the freezing cylinder 10. A first pair of the beater elements 2134′ is radially and respectively extended at two opposing sides of a front portion of the axial bar 2131′, having the same length and being aligned in opposite direction radially. A second pair of the beater elements 2134′ is radially and respectively extended at two opposing sides of a rear portion of the axial bar 2131′, having the same length and being aligned in opposite direction radially. A third pair and a fourth pair of the beater elements 2134′ are radially and spacedly extended at two opposing sides of a portion between the front portion and the rear portion of the axial bar 2131′, having the same length and being aligned in opposite directions radially. The four pairs of beater elements 2134′ are positioned in stagger manner that not only provides more even and better stirring, smashing and mixing ability for the mixture in the mixing chamber 100, but also provides rigid and balancing support to the pair of the helical stirring paddles 212′.

Each of the pair of stirring paddles 212′ is preferred to be extended in a 180~360 degrees spiral manner, preferably 270 degrees, along the length of the axial bar 2131′ (the mixing chamber 100) of the freezing cylinder 10, wherein the two helical stirring paddles 212′ are preferred to be spirally extended in opposite directions such that, in every cross section of the stirring apparatus 20′ within the freezing cylinder 10, the two stirring paddles 212′ are opposing with each other. In other word, the two stirring paddles 212′ are extended along the entire length of the mixing chamber 100 and the inner surface 110 of the freezing cylinder 10 are continuously scraped by the pair of scraper blades 22′ symmetrically.

It is noted that the axial bar 2131′ and each of the beater elements 2134′ may have any sectional shape. According to the preferred embodiment, the axial bar 2131′ and the beater elements 2134′ are embodied to each having a circular sectional shape that is good for mixture stirring and smashing effect.

Since the pair of stirring paddles 212′ are helically extended in a symmetrical manner, the first pair of the beater elements 2134′ are outwardly and radially extended from the front end portion of the axial bar 2131′ to connect with the stirring paddles 212′ respectively, the third and fourth pairs of the beater elements 2134′ are outwardly and radially extended from between front portion and the rear portion of the axial bar 2131′ to connect with the stirring paddles 212′ respectively, so as to rigidly support the pair of stirring paddles 212′ to extended along the mixing chamber 100 of the freezing cylinder 10 in the spiral manner.

Generally, the ingredients of the mixture fed through the inlet 11 into the mixing chamber 100 of the freezing cylinder 10 are well smashed and mixed by the beater elements 2134′ in the middle and rear section of mixing chamber 100 of the freezing cylinder 10, i.e. the section that the axial bar 2131′ is positioned, and the stirring paddles 212′ and the mixture is frozen to produce the ice cream or yogurt product, which is ready to discharge through the outlet 12 of the freezing cylinder 10, in the front section of the mixing chamber 100 of the freezing cylinder 10, i.e. the section between the front supporter 211′ and the front end portion of the axial bar 2131′. In order to further support the pair of stirring paddles 212′ and provide additional stirring effect to the mixture in the front section of the mixing chamber 100 of the freezing cylinder 10, the stirring beater 21 further comprises a beater ring 23′ positioned between the front supporter 211′ and the axial bar 2131′ and coaxially and integrally connected with the pair of the stirring paddles 212′, such that the front portion of each of the stirring paddles 212′ is well supported by the beater ring 23′ and the beater ring 23′ also provides a stirring and continuously mixing effect to the frost mixture in the front section of mixing chamber 100 before discharging through the outlet 12 of the freezing cylinder 10.

According to the alternative mode of the above preferred embodiment, the front supporter 211′ comprises a tubular supporter body 2111′ having an axial opening 2110′ for rotatably mounting on the front member 101 of the freezing cylinder 10 so as to rotatably and coaxially support the stirring beater 21′ to the front member 101 of the freezing cylinder 10. In other words, the rotatably connection of the front member 101 and the rear member 102 of the freezing cylinder 10 with the front supporter 211′ and the end rotor 2132′ respectively, the stirring beater 21′ is coaxially support in the mixing chamber 100 of the freezing cylinder 10 in a rotatable manner. The front portion of each of the stirring beaters 212′ is extended to the front supporter 211′ to provide stirring and mixing effect to the frost mixture before discharged through the outlet 12.

Since the pair of the stirring paddles 212′ and the pair of the scraper blades 22′ are integrally formed and made of plastic, the retaining rails 2121, retaining slots 221 and retainers 2122, 2123 of the above preferred embodiment are omitted. The outer sides of the pair of scraper blades 22′ are preferred to be touching on the inner surface 110 of the freezing cylinder 10. The pair scraper blades 22′ are also able to be arranged to form a gap between the inner surface 110 of the freezing cylinder 10 and the outer sides of the pair of scraper blades 22′.

Since inner diameter of the mix chamber 100 becomes smaller when a layer of frost mixture is firmly attached to the inner surface 110 of the freezing cylinder 10 that the scraper blade 22 may not remove the entire mixture attached to the inner surface 110 once a time, the V configuration of the pair of scaping arms 222 and the formation of the scraper cavity 225 provides a cushion effect that enables the scraper blade 22 to reduce its overall thickness by pressing the scraping edges 2221 inwards to continuously move and pass through while the scraper blade 22 is rotated to shave a portion of the frost mixture in a rotation circle. The scraper blades 22 are continued to be rotated to shave the mixture around and around, the mixture will be removed portion by portion or be shaven around by around from the inner surface 110. It is appreciated that a radius of scraping circle of the scraper blades 22 is fine-tuning while rotating against the inner surface 110 to scrap the frost mixture.

Similar to the above preferred embodiment, the stirring beater 21′ stirs and moves the mixture from the inlet 11 to the outlet 12 by the helical stirring paddles 212′ and from the inner surface 110 to a center of the freezing cylinder 10 by the scraper blades 22′. The beater elements 2134 inside the stirring beater 21 are blocking the flowing path of the mixture that significantly smash the ingredients of mixture into pieces and stir the ingredients of mixture back again to evenly mix the mixture with the stirring paddles 212 Thus, the mixture is moving along the inner spiral line pushed by the stirring beater 21′ and bumped into the beater elements 2134′ and the beater ring 23′. Even the front supporter 211′ also provides the stirring and mixing effect for the mixture near the outlet 12 so as to ensure well mixed mixture to discharge through the outlet 12.

Referring to FIG. 9, another alternative mode of the above preferred embodiment of the present invention is illustrated, wherein the stirring apparatus 20″ generally has the same structural configuration of the above alternative mode as shown in FIG. 7 but having a smaller size for freezing cylinder having smaller size and volume, wherein only three pairs of beater elements 2134″ are provided on a shorter axial bar 213″. Accordingly,

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A stirring apparatus for a direct expansion evaporation of ice cream or yogurt machine, which comprises a freezing cylinder having a mixing chamber therein, an inner surface, an inlet, and an outlet, the stirring apparatus comprising:
a stirring beater, configured for being coaxially disposed in the mixing chamber of the freezing cylinder in a rotatable manner for pushing a mixture to flow in the mixing chamber in an inner spiral manner while stirring, smashing and mixing the mixture which is served as frozen product out of the freezing cylinder, comprising:
a front supporter configured for being rotatably mounted to a front end of the freezing cylinder,
one or more helical stirring paddles, and
a central frame configured to support said one or more helical stirring paddles spirally extended from said front supporter to a rear end portion thereof; and
one or more scraper blades provided along said one or more stirring paddles respectively to define a helical diameter for matching with an inner diameter of the mixing chamber of the freezing cylinder, such that each of said one or more scraper blades is capable of scrapping the mixture frozen on the inner surface of said freezing cylinder while a rotation of said stirring beater within the mixing chamber of the freezing cylinder.

2. The stirring apparatus, as recited in claim 1, wherein said stirring beater comprises a pair of said stirring paddles and a pair of said scraper blades, wherein said two helical stirring paddles are spirally extended in opposite directions and each of said pair of said stirring paddles is extended in a spiral manner for 180-270 degrees along a length of the mixing chamber of the freezing cylinder.

3. The stirring apparatus, as recited in claim 1, wherein said central frame comprises an axial bar, an end rotor radially protruded at a rear end of said axial bar for mounting to a rear end of the freezing cylinder, a driven shaft rearwardly extended from said end rotor for being driven by a motor of said freezing cylinder to rotate said central frame in the mixing chamber coaxially, and two or more beater elements radially extended from said axial bar to connect with two or more of said stirring paddles respectively, so as to be positioned around said axial bar and surrounded by said stirring paddles radially, thereby when the mixture is moving along an inner spiral line pushed by said stirring beater, said beater elements block a flowing path of the mixture to mix and smash the mixture in an inner portion of the mixing chamber.

4. The stirring apparatus, as recited in claim 2, wherein said central frame comprises an axial bar, an end rotor radially protruded at a rear end of said axial bar for mounting to a rear end of the freezing cylinder, a driven shaft rearwardly extended from said end rotor for being driven by a motor of said freezing cylinder to rotate said central frame in the mixing chamber coaxially, and two or more beater elements radially extended from said axial bar to connect with said two or more of said stirring paddles respectively, so as to be positioned around said axial bar and surrounded by said stirring paddles radially, thereby when the mixture is moving along an inner spiral line pushed by said stirring beater, said beater elements block a flowing path of the mixture to mix and smash the mixture in an inner portion of the mixing chamber.

5. The stirring apparatus, as recited in claim 3, wherein said stirring beater further comprises a beater ring positioned between said front supporter and said axial bar and coaxially connected with said two or more stirring paddles.

6. The stirring apparatus, as recited in claim 4, wherein said stirring beater further comprises a beater ring positioned between said front supporter and said axial bar and coaxially connected with said two or more stirring paddles.

7. The stirring apparatus, as recited in claim 4, wherein a first pair of said beater elements is radially and respectively extended at two opposing sides of a front portion of said axial bar, a second pair of said beater elements is radially and respectively extended at two opposing sides of a rear portion of said axial bar, and at least a third pair of aid beater elements is radially and respectively extended at two opposing sides of a portion between said front portion and said rear portion of said axial bar.

8. The stirring apparatus, as recited in claim 6, wherein a first pair of said beater elements is radially and respectively extended at two opposing sides of a front portion of said axial bar, a second pair of said beater elements is radially and respectively extended at two opposing sides of a rear portion of said axial bar, and at least a third pair of aid beater elements is radially and respectively extended at two opposing sides of a portion between said front portion and said rear portion of said axial bar.

9. The stirring apparatus, as recited in claim 2, wherein said two scraper blades are detachably mounted on outer sides of said two stirring paddles respectively, wherein each of said scraper blades comprises two scraping arms outwardly and slantly extended from two longitudinal sides thereof in a symmetrical manner and has a concave recess formed and extended longitudinally along an outer side thereof, wherein each of said scraping arms gradually reduces a thickness thereof to from a scraping edge configured for pressing against the inner surface of the freezing cylinder, thereby when said stirring beater is rotatably disposed in the mixing chamber of the freezing cylinder, said two scraper blades are supported to touch the inner surface of the freezing cylinder and only said two scraping edges of said two scraper arms of each of said scraper blades are pressing against the inner surface during rotation of said scraper blade, wherein a scraper cavity is defined between said two scraping edges of said two scraper arms and the inner surface of the freezing cylinder.

10. The stirring apparatus, as recited in claim 9, wherein a central ridge is slightly protruded along said outer side of each of said scraper blades that reinforces said two scraper arms and ensures a flexibility of said two scraping edges for pressing against the inner surface of the freezing cylinder while said stirring beater is rotating within the mixing chamber coaxially.

11. The stirring apparatus, as recited in claim 1, wherein said one or more scraper blades are detachably mounted on said one or more stirring paddles respectively through a rail and slot configuration.

12. The stirring apparatus, as recited in claim 4, wherein said two scraper blades are detachably mounted on said two stirring paddles respectively through a rail and slot configuration.

13. The stirring apparatus, as recited in claim 9, wherein said two scraper blades are detachably mounted on said two stirring paddles respectively through a rail and slot configuration.

14. The stirring apparatus, as recited in claim 1, wherein said one or more scraper blades are integrally formed at outer edges of said one or more stirring paddles respectively.

15. The stirring apparatus, as recited in claim 2, wherein said two scraper blades are integrally formed at outer edges of said two stirring paddles respectively.

16. The stirring apparatus, as recited in claim 3, wherein said one or more scraper blades are integrally formed at outer edges of said one or more stirring paddles respectively.

17. The stirring apparatus, as recited in claim 4, wherein said two scraper blades are integrally formed at outer edges of said two stirring paddles respectively.

18. The stirring apparatus, as recited in claim 5, wherein said one or more scraper blades are integrally formed at outer edges of said one or more stirring paddles respectively.

19. The stirring apparatus, as recited in claim 6, wherein said two scraper blades are integrally formed at outer edges of said two stirring paddles respectively.

20. The stirring apparatus, as recited in claim 7, wherein said one or more scraper blades are integrally formed at outer edges of said one or more stirring paddles respectively.

21. The stirring apparatus, as recited in claim 8, wherein said two scraper blades are integrally formed at outer edges of said two stirring paddles respectively.

22. The stirring apparatus, as recited in claim 11, wherein each of said stirring paddles comprises a retaining rail protruded along an outer side thereof and each of said scraper blades has a retaining slot indented along an inner side thereof to engage with said retaining rail of said corresponding stirring paddle to form the rail and slot configuration so as to detachably retain said scraper blade on said outer side of said stirring paddle.

23. The stirring apparatus, as recited in claim 12, wherein each of said stirring paddles comprises a retaining rail protruded along an outer side thereof and each of said scraper blades has a retaining slot indented along an inner side thereof to engage with said retaining rail of said corresponding stirring paddle to form the rail and slot configuration so as to detachably retain said scraper blade on said outer side of said stirring paddle.

24. The stirring apparatus, as recited in claim 13, wherein each of said stirring paddles comprises a retaining rail protruded along an outer side thereof and each of said scraper blades has a retaining slot indented along an inner side thereof to engage with said retaining rail of said corresponding stirring paddle to form the rail and slot configuration so as to detachably retain said scraper blade on said outer side of said stirring paddle.

25. The stirring apparatus, as recited in claim 22, wherein each of said stirring paddles comprises a front retainer and a rear retainer provided at a front end and a rear end thereof, wherein each of said front retainer and said rear retainer forms a retainer slot such that a front end portion and a rear portion of said corresponding scraper blade detachably mounted on said stirring paddle are received and retained in said retainer slots of said front retainer and said rear retainer respectively.

26. The stirring apparatus, as recited in claim 23, wherein each of said stirring paddles comprises a front retainer and a rear retainer provided at a front end and a rear end thereof, wherein each of said front retainer and said rear retainer forms a retainer slot such that a front end portion and a rear portion of said corresponding scraper blade detachably mounted on said stirring paddle are received and retained in said retainer slots of said front retainer and said rear retainer respectively.

27. The stirring apparatus, as recited in claim 24, wherein each of said stirring paddles comprises a front retainer and a rear retainer provided at a front end and a rear end thereof, wherein each of said front retainer and said rear retainer forms a retainer slot such that a front end portion and a rear portion of said corresponding scraper blade detachably mounted on said stirring paddle are received and retained in said retainer slots of said front retainer and said rear retainer respectively.
